(19) United States
(12) Patent Application Publication
(10) Pub. No.: US 2008/0106095 A1
(43) Pub. Date: May 8, 2008

(54) Heater core connector tube

(76) Inventors: Richard K. Harris, Pinckney, MI (US); Joseph Nader, Port Sanilac, MI (US); Fred G. Schroeder, Grosse Ile, MI (US); William E. Kolasa, St. Clair Shores, MI (US)

Correspondence Address: FRASER CLEMENS MARTIN & MILLER LLC, 28366 KENSINGTON LANE, PERRYSBURG, OH, 43551, US

(21) Appl. No.: 11/594,548

(22) Filed: Nov. 8, 2006

(51) Int. Cl. F16L 43/00

(52) U.S. Cl. 285/179

(57) ABSTRACT

A connector tube for a heater core is shown, wherein the connector tube facilitates a connection to a plurality of heater core extension tubes having different geometries.

### FIELD OF THE INVENTION

The present invention relates to a heater core connector tube and more particularly to a heater core connector tube that facilitates connection to a plurality of different geometries of heater core extension tubes.

### BACKGROUND OF THE INVENTION

Heater core connector tubes are typically used to connect heat exchanger tanks to heater core extension tubes. Depending on the length and the geometry of the extension tube, the extension tube may or may not be included with an initial braze of the heater core and connector tubes. Some extension tubes are attached to the heat exchanger tanks by open flame brazing using a non-corrosive flux. This can leave flux residue that can be subsequently enter the passenger compartment, which is undesirable. Prior art attempts to militate against the entrance of the flux into the passenger compartment are expensive and time consuming.

Under certain circumstances, the extension tubes are too long or complex to be included in the initial braze. In these situations, secondary operations are used to connect the extension tubes to the connector tubes. Since male ends of heater core extension tubes have different geometries, female ends of connector tubes must have conforming geometries to facilitate a correct connection to the extension tubes.

To accommodate the different geometries of male extension tubes, separate connector tubes having conforming female ends for each of the different male ends have been developed. Some prior art connector tubes include O-rings and clamps to assist in creating a fluid tight connection between the extension tube and the connector tube. Time and effort is consumed to make necessary precautions when connecting the connector tube to the extension tube, such as selecting the proper connector tube and employing O-rings and the like, for example. If the wrong connector tube is used, or secondary structure left out, a quality of the connection between the extension tube and the connector tube is reduced, which is undesirable.

It would be desirable to produce a connector tube having a geometry that conforms to a plurality of extension tubes, wherein an ease of assembly and an efficiency of a connection with the extension tube are maximized.

### SUMMARY OF THE INVENTION

Harmonious with the present invention, a connector tube having a geometry that conforms to a plurality of extension tubes, wherein an ease of assembly and an efficiency of a connection with the extension tube are maximized, has surprisingly been disconnected.

In one embodiment, a connector tube comprises: a first end with a radially outwardly extending first flared portion formed thereon, wherein the first end is adapted to connect to a male end of a tube; a spaced apart second end adapted to be connected to a tank; and an intermediate portion disposed between the first end and the second end, the intermediate portion including an inner surface having a second flared portion formed thereon, the second flared portion adapted to abut an end of the tube.

In another embodiment, a connector tube comprises: a first end substantially circular in cross section with a radially outwardly extending first flared portion formed thereon, wherein the first end is adapted to connect to a male end of a tube, the connection secured by one of a clamp, a crimp, and a braze; a spaced apart second end substantially rectangular in cross section, wherein the second end adapted to be connected to a tank; and an intermediate portion disposed between the first end and the second end, the intermediate portion including an inner surface having a second flared portion formed thereon, the second flared portion adapted to abut an end of the tube.

In another embodiment, a fluid conveying system comprises: an extension tube; a heat exchanger tank; and a connector tube having a first end, a spaced apart second end, and an intermediate portion disposed between the first end and the second end, the first end including a first flared portion formed thereon adapted to be connected to an end of the extension tube, the second end adapted to be connected to the heat exchanger tank, and the intermediate portion including a second flared portion adapted to abut the end of the extension tube.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a side sectional view of a connection between an extension tube, a connector tube, and a heat exchanger tank, in accordance with an embodiment of the invention;

FIG. 2 is a side sectional view of a connection between an extension tube, a connector tube, and a heat exchanger tank, in accordance with another embodiment of the invention;

FIG. 3 is a side sectional view of a connection between an extension tube, a connector tube, and a heat exchanger tank, in accordance with another embodiment of the invention;

FIG. 4 is a side sectional view of a connection between an extension tube, a connector tube, and a heat exchanger tank, in accordance with another embodiment of the invention;

FIG. 5 is a side sectional view of a connection between an extension tube, a connector tube, and a heat exchanger tank, in accordance with another embodiment of the invention; and

FIG. 6 is a side sectional view of a connection between an extension tube, a connector tube, and a heat exchanger tank, in accordance with another embodiment of the invention.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

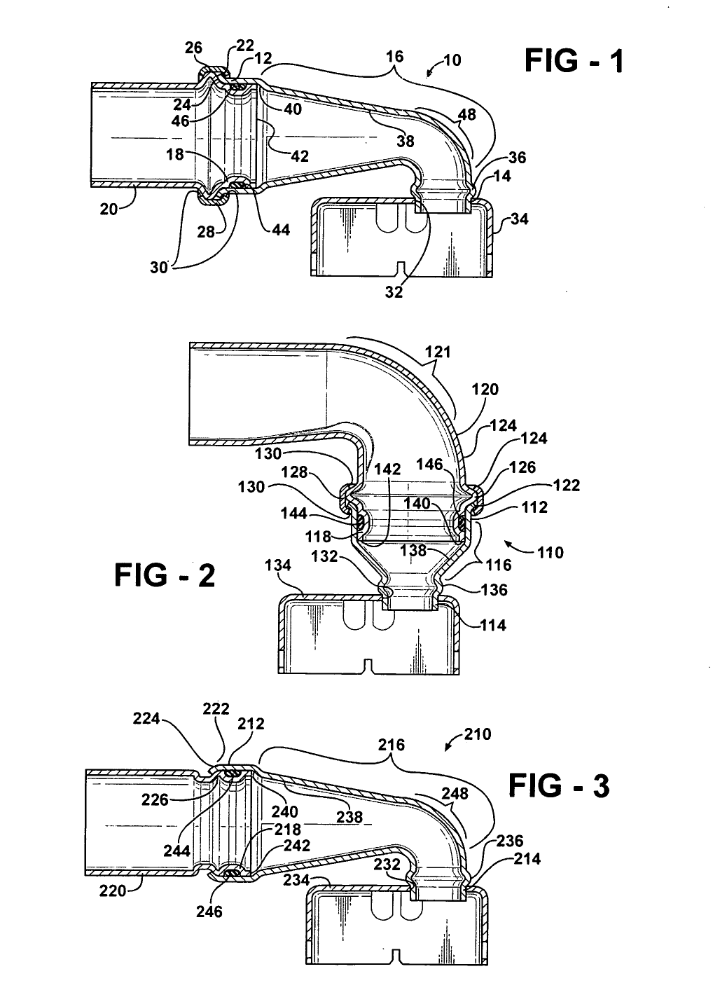

FIG. 1 shows a connector tube 10 in accordance with an embodiment of the invention. The connector tube 10 is typically formed from aluminum. However, other materials can be used to form the connector tube 10 as desired. The connector tube 10 includes a first end 12, a second end 14, and an intermediate portion 16 disposed between the first end 12 and the second end 14.

The first end 12 of the connector tube 10 is substantially circular in cross section and is adapted to receive a male end 18 of an extension tube 20. A first flared portion 22 is formed on the first end 12. The first flared portion 22 is flared radially outwardly from the first end 12. A distal end 24 of the first flared portion 22 is adapted to abut a radially outwardly extending lip 26 formed on the extension tube 20. A clamp 28 is disposed around the first flared portion 22 of the connector tube 10 and the lip 26 of the extension tube 20. In the embodiment shown, the clamp 28 includes a pair of opposed, radially inwardly extending lips 30 that engage the first flared portion 22 of the connector tube 10 and the lip 26 of the extension tube 20. It is understood that clamps having other shapes and configurations can be used as desired without departing from the scope and spirit of the invention.

The second end 14 of the connector tube 10 is substantially rectangular in cross section and is adapted to be connected to an inlet 32 of a heat exchanger tank 34. It is understood that the second end 14 may have other cross sectional shapes and can be connected to other structures as desired without departing from the scope and spirit of the invention, such as an outlet (not shown) of the heat exchanger tank 34. A radially outwardly extending shoulder 36 adapted to abut an external surface of the heat exchanger tank 34 is formed on the second end 14 of the conduit 10.

The intermediate portion 16 of the connector tube 10 has an inner surface 38 having a second flared portion 40 that is adapted to abut a distal end 42 of the extension tube 20. The inner surface 38 is adapted to engage an O-ring 44 that is optionally disposed in a channel 46 formed in the extension tube 20. While a single O-ring 44 is shown in the drawings, additional O-rings may be disposed in the channel 46 or in additional channels (not shown) as desired. In the embodiment shown, the intermediate portion 16 includes a bend 48 of substantially ninety degrees formed therein.

In use, the first end 12 of the connector tube 10 receives the extension tube 20 and the distal end 42 of the extension tube 20 abuts the second flared portion 40. The O-ring 44 disposed between the extension tube 20 and the inner surface 38 of the connector tube 10 forms a substantially fluid tight seal therebetween. The clamp 28 is secured to the first flared portion 22 of the connector tube 10 and the extension tube 20 to militate against relative axial movement therebetween. The second end 14 of the connector tube 10 is received in and brazed or otherwise connected to the inlet 32 of the heat exchanger tank 34.

A fluid (not shown) is caused to flow through the extension tube 20 into the conduit 10. The fluid flows through the connector tube 10 and out of the connector tube 10 into the heat exchanger tank 34. It is understood that if the connector tube 10 is connected to the outlet of the heat exchanger tank 34, the flow path is reversed.

FIG. 2 shows a connector tube 110 in accordance with another embodiment of the invention. The connector tube 110 is typically formed from aluminum. However, other materials can be used to form the connector tube 110 as desired. The connector tube 110 includes a first end 112, a second end 114, and an intermediate portion 116 disposed between the first end 112 and the second end 114.

The first end 112 of the connector tube 110 is substantially circular in cross section and is adapted to receive the male end 118 of an extension tube 120. In the embodiment shown, the extension tube 120 has a bend 121 of approximately ninety degrees formed therein. A first flared portion 122 is formed on the first end 112. The first flared portion 122 is flared radially outwardly from the first end 112. A distal end 124 of the first flared portion 122 is adapted to abut a radially outwardly extending lip 126 formed on the extension tube 120. A clamp 128 is disposed around the first flared portion 122 of the connector tube 110 and the lip 126 of the extension tube 120. In the embodiment shown, the clamp 128 includes a pair of opposed, radially inwardly extending lips 130 that engage the first flared portion 122 of the connector tube 110 and the lip 126 of the extension tube 120. It is understood that clamps having other shapes and configurations can be used as desired without departing from the scope and spirit of the invention.

The second end 114 of the connector tube 110 is substantially rectangular in cross section and is adapted to be connected to an inlet 132 of a heat exchanger tank 134. It is understood that the second end 114 may have other cross sectional shapes and can be connected to other structures as desired without departing from the scope and spirit of the invention, such as an outlet (not shown) of the heat exchanger tank 134. A radially outwardly extending shoulder 136 adapted to abut an external surface of the heat exchanger tank 134 is formed on the second end 114 of the connector tube 110.

The intermediate portion 116 of the connector tube 110 includes an inner surface 138 having a second flared portion 140 that is adapted to abut a distal end 142 of the extension tube 120. The inner surface 138 is adapted to engage an O-ring 144 that is optionally disposed in a channel 146 formed in the extension tube 120. While a single O-ring 144 is shown in the drawings, additional O-rings may be disposed in the channel 146 or in additional channels (not shown) as desired.

Use of the connector tube 110 is substantially similar to use of the connector tube 10 described above for FIG. 1.

FIG. 3 shows a connector tube 210 in accordance with another embodiment of the invention. The connector tube 210 is typically formed from aluminum. However, other materials can be used to form the connector tube 210 as desired. The connector tube 210 includes a first end 212, a second end 214, and an intermediate portion 216 disposed between the first end 212 and the second end 214.

The first end 212 of the connector tube 210 is substantially circular in cross section and is adapted to receive the male end 218 of an extension tube 220. A first flared portion 222 is formed on the first end 212. The first flared portion 222 is flared radially outwardly from the first end 212. A distal end 224 of the first flared portion 222 is crimped or otherwise caused to be formed around a radially outwardly extending lip 226 formed on the extension tube 220. It is understood that only a portion of the first flared portion 222 can be formed around the radially outwardly extending lip 226 formed on the extension tube 220.

The second end 214 of the connector tube 210 is substantially rectangular in cross section and is adapted to be connected to an inlet 232 of a heat exchanger tank 234. It is understood that the second end 214 may have other cross sectional shapes and can be connected to other structures as desired without departing from the scope and spirit of the invention, such as an outlet (not shown) of the heat exchanger tank 234. A radially outwardly extending shoulder 236 adapted to abut and external surface of the heat exchanger tank 234 is formed on the second end 214 of the connector tube 210.

The intermediate portion 216 of the connector tube 210 has an inner surface 238 having a second flared portion 240 that is adapted to abut a distal end 242 of the extension tube 220. The inner surface 238 is adapted to engage an O-ring 244 that is disposed in a channel 246 formed in the extension tube 220. While a single O-ring 244 is shown in the drawings, additional O-rings may be disposed in the channel 246 or in additional channels (not shown) as desired. In the embodiment shown, the intermediate portion 216 includes a bend 248 of substantially ninety degrees formed therein.

In use, the first end 212 of the connector tube 210 receives the extension tube 220 and the distal end 242 of the extension tube 220 abuts the second flared portion 240. The O-ring 244 disposed between the extension tube 220 and the inner surface 238 of the connector tube 210 forms a substantially fluid tight seal therebetween. The distal end 224 of the first flared portion 222 formed on the connector tube 210 is crimped over the lip 226 formed on the extension tube 220. The crimping of the first flared portion 222 facilitates a connection between the connector tube 210 and the extension tube 222 and militates against relative axial movement therebetween. The second end 214 of the connector tube 210 is received in and brazed or otherwise connected to the inlet 232 of the heat exchanger tank 234.

A fluid (not shown) is caused to flow through the extension tube 220 into the connector tube 210. The fluid flows through the connector tube 210 and out of the connector tube 210 into the heat exchanger tank 234. It is understood that if the connector tube 210 is connected to the outlet of the heat exchanger tank 234, the flow path is reversed.

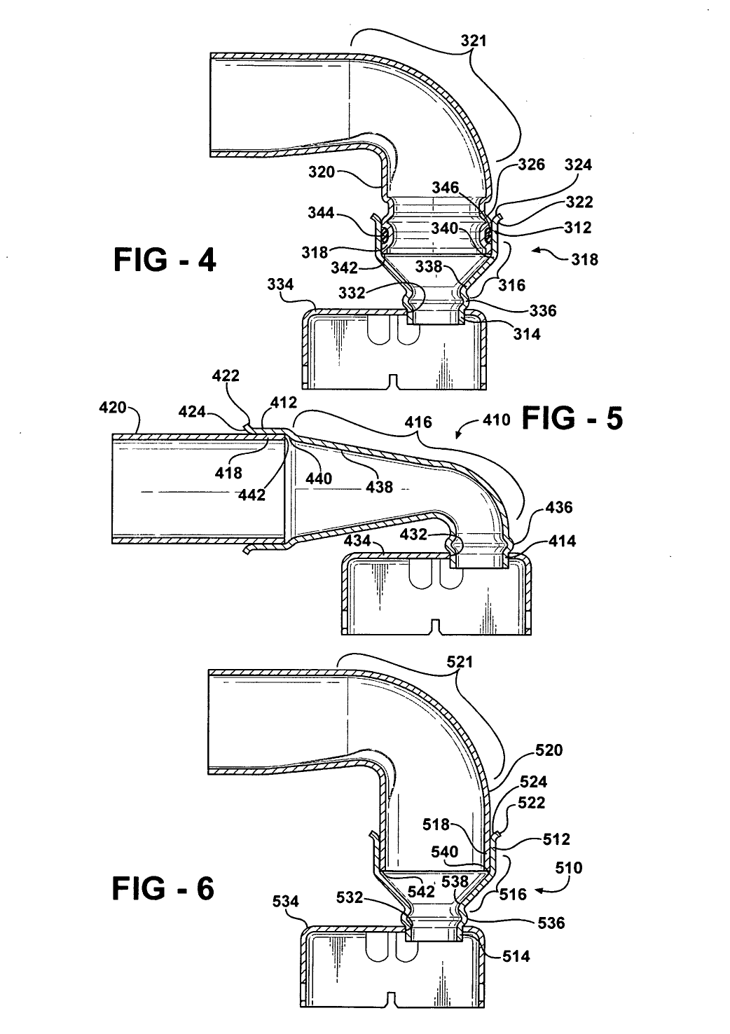

FIG. 4 shows a connector tube 310 in accordance with another embodiment of the invention. The connector tube 310 is typically formed from aluminum. However, other materials can be used to form the connector tube 310 as desired. The connector tube 310 includes a first end 312, a second end 314, and an intermediate portion 316 disposed between the first end 312 and the second end 314.

The first end 312 of the connector tube 310 is substantially circular in cross section and is adapted to receive the male end 318 of an extension tube 320. In the embodiment shown, the extension tube 320 has a bend 321 of approximately ninety degrees formed therein. A first flared portion 322 is formed on the first end 312. The first flared portion 322 is flared radially outwardly from the first end 312. A distal end 324 of the first flared portion 322 is adapted to be crimped or otherwise caused to be formed around a radially outwardly extending lip 326 formed on the extension tube 320.

The second end 314 of the connector tube 310 is substantially rectangular in cross section and is adapted to be connected to an inlet 332 of a heat exchanger tank 334. It is understood that the second end 314 may have other cross sectional shapes and can be connected to other structures as desired without departing from the scope and spirit of the invention, such as an outlet (not shown) of the heat exchanger tank 334. A radially outwardly extending shoulder 336 adapted to abut an external surface of the heat exchanger tank 334 is formed on the second end 314 of the connector tube 310.

The intermediate portion 316 of the connector tube 310 includes an inner surface 338 having a second flared portion 340 that is adapted to abut a distal end 342 of the extension tube 320. The inner surface 338 is adapted to engage an O-ring 344 that is optionally disposed in a channel 346 formed in the extension tube 320. While a single O-ring 344 is shown in the drawings, additional O-rings may be disposed in the channel 346 or in additional channels (not shown) as desired.

Use of the connector tube 310 is substantially similar to use of the connector tube 210 described above for FIG. 3.

FIG. 5 shows a connector tube 410 in accordance with another embodiment of the invention. The connector tube 410 is typically formed from aluminum. However, other materials can be used to form the connector tube 410 as desired. The connector tube 410 includes a first end 412, a second end 414, and an intermediate portion 416 disposed between the first end 412 and the second end 414.

The first end 412 of the connector tube 410 is substantially circular in cross section is adapted to receive the male end 418 of an extension tube 420. A first flared portion 422 is formed on the first end 412. The first flared portion 422 is flared radially outwardly from the first end 412. An inner surface 424 of the first flared portion 422 is adapted receive a braze ring, a paste, or the like for connecting the connector tube 410 to the extension tube 420.

The second end 414 of the connector tube 410 is substantially rectangular in cross section and is adapted to be connected to an inlet 432 of a heat exchanger tank 434. It is understood that the second end 414 may have other cross sectional shapes and can be connected to other structures as desired without departing from the scope and spirit of the invention, such as an outlet (not shown) of the heat exchanger tank 434. A radially outwardly extending shoulder 436 adapted to abut an outer surface of the heat exchanger tank 434 is formed on the second end 414 of the connector tube 410.

The intermediate portion 416 of the connector tube 410 has an inner surface 438 having a second flared portion 440 that is adapted to abut a distal end 442 of the extension tube 420.

In use, the first end 412 of the connector tube 410 receives the extension tube 420 and the distal end 442 of the extension tube 420 abuts the second flared portion 440. The braze ring, paste, or the like is disposed on the inner surface 424 of the first flared portion 422 of the connector tube 410. The connector tube 410 is then brazed or otherwise connected to the extension tube 420. The connection militates against relative movement between the connector tube 410 and the extension tube 420 and forms a substantially fluid tight seal therebetween. The second end 414 of the connector tube 410 is received in and brazed or otherwise connected to the inlet 432 of the heat exchanger tank 434.

A fluid (not shown) is caused to flow through the extension tube 420 into the connector tube 410. The fluid flows through the connector tube 410 and out of the connector tube 410 into the heat exchanger tank 434. It is understood that if the connector tube 410 is connected to the outlet of the heat exchanger tank 434, the flow path is reversed. If service to the extension tube 420, the connector tube 410, or the heat exchanger tank 434 is required, the brazed connection between the extension tube 420 and the connector tube 410 or between the connector tube 410 and the heat exchanger tank 434 can be broken to provide access to the part in need of service.

FIG. 6 shows a connector tube 510 in accordance with another embodiment of the invention. The connector tube 510 is typically formed from aluminum. However, other materials can be used to form the connector tube 510 as desired. The connector tube 510 includes a first end 512, a second end 514, and an intermediate portion 516 disposed between the first end 512 and the second end 514.

The first end 512 of the connector tube 510 is substantially circular in cross section and is adapted to receive the male end 518 of an extension tube 520. In the embodiment shown, the extension tube 520 has a bend 521 of approximately ninety degrees formed therein. A first flared portion 522 is formed on the first end 512. The first flared portion 522 is flared radially outwardly from the first end 512. An inner surface 524 of the first flared portion 522 is adapted receive a braze ring, a paste, or the like for connecting the connector tube 510 to the extension tube 520.

The second end 514 of the connector tube 510 is substantially rectangular in cross section and is adapted to be connected to an inlet 532 of a heat exchanger tank 534. It is understood that the second end 514 may have other cross sectional shapes and can be connected to other structures as desired without departing from the scope and spirit of the invention, such as an outlet (not shown) of the heat exchanger tank 534. A radially outwardly extending shoulder 536 adapted to abut an outer surface of the heat exchanger tank 534 is formed on the second end 514 of the connector tube 510.

The intermediate portion 516 of the connector tube 510 includes an inner surface 538 having a second flared portion 540 that is adapted to abut a distal end 542 of the extension tube 520.

Use of the connector tube 510 is substantially similar to use of the connector tube 410 described above for FIG. 5.

The conduits 10, 210, 410 discussed above in FIGS. 1, 3, and 5 have substantially similar geometries and are interchangeable, regardless of the geometry of the male end 18, 218, 418 of the extension tube 20, 220, 420 which the conduit 10, 210, 410 will be connected to. Similarly, the conduits 110, 310, 510 discussed above in FIGS. 2, 4, and 6 have substantially similar geometries and are interchangeable, regardless of the geometry of the male end 118, 318, 518 of the extension tube 120, 320, 520 which the connector tube 110, 310, 510 will be connected to. Accordingly, a need for separate connectors having geometries that are connectable to six different types of extension tubes is minimized, and an assembly time is minimized. Additionally, since the connectors 10, 110, 210, 310, 410, 510 discussed above are connected directly to the extension tubes 20, 120, 220, 320, 420, 520, a need for additional tubes or conduits necessary for creating a flow path between the heat exchanger tank and the extension tube is minimized.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A connector tube comprising:
a first end with a radially outwardly extending first flared portion formed thereon, wherein the first end is adapted to connect to a male end of a tube;
a spaced apart second end adapted to be connected to a tank; and
an intermediate portion disposed between the first end and the second end, the intermediate portion including an inner surface having a second flared portion formed thereon, the second flared portion adapted to abut an end of the tube.

2. The connector tube according to claim 1, wherein the tank is a heat exchanger tank.

3. The connector tube according to claim 1, wherein the tube is an extension tube.

4. The connector tube according to claim 1, wherein the first end is substantially circular in cross section and the second end is substantially rectangular in cross section.

5. The connector tube according to claim 1, wherein the connection between the first flared portion formed on the first end of the connector tube and the male end of the tube is secured by one of a clamp, a crimp, and a braze.

6. The connector tube according to claim 1, wherein the conduit is formed from aluminum.

7. The connector tube according to claim 1, wherein the inner surface of the intermediate portion is adapted to receive at least one of an O-ring and a braze ring.

8. The connector tube according to claim 1, wherein the intermediate portion includes a bend formed therein.

9. The connector tube according to claim 8, wherein the bend is approximately ninety degrees.

10. The connector tube according to claim 1, wherein the second end includes a radially outwardly extending shoulder formed thereon.

11. A connector tube comprising:
a first end substantially circular in cross section with a radially outwardly extending first flared portion formed thereon, wherein the first end is adapted to connect to a male end of a tube, the connection secured by one of a clamp, a crimp, and a braze;
a spaced apart second end substantially rectangular in cross section, wherein the second end adapted to be connected to a tank; and
an intermediate portion disposed between the first end and the second end, the intermediate portion including an inner surface having a second flared portion formed thereon, the second flared portion adapted to abut an end of the tube.

12. The connector tube according to claim 11, wherein the conduit is formed from aluminum.

13. The connector tube according to claim 11, wherein the inner surface of the intermediate portion is adapted to receive at least one of an O-ring and a braze ring.

14. The connector tube according to claim 11, wherein the intermediate portion includes a bend formed therein.

15. The connector tube according to claim 14, wherein the bend is approximately ninety degrees.

16. The connector tube according to claim 11, wherein the second end includes a radially outwardly extending shoulder formed thereon.

17. A fluid conveying system comprising:
an extension tube;
a heat exchanger tank; and
a connector tube having a first end, a spaced apart second end, and an intermediate portion disposed between the first end and the second end, the first end including a first flared portion formed thereon adapted to be connected to an end of the extension tube, the second end adapted to be connected to the heat exchanger tank, and the intermediate portion including a second flared portion adapted to abut the end of the extension tube.

18. The fluid conveying system according to claim 17, wherein the intermediate portion includes a bend of approximately ninety degrees formed therein, the first end of the connector tube is substantially circular in cross section, and the second end of the connector tube is substantially rectangular in cross section.

19. The fluid conveying system according to claim 17, wherein the inner surface of the intermediate portion adapted to receive at least one of an O-ring and a braze ring.

20. The fluid conveying system according to claim 17, wherein the connection between the first flared portion formed on the first end of the connector tube and the end of the extension tube is secured by one of a clamp, a crimp, and a braze.
